(19) United States
(12) Patent Application Publication
(10) Pub. No.: US 2025/0045324 A1
(43) Pub. Date: Feb. 6, 2025

(54) Methods and Systems for Storing Object Information With Contextual Information

(71) Applicant: Apple Inc., Cupertino, CA (US)

(72) Inventors: Christopher D. Fu, Fremont, CA (US); Devin W. Chalmers, Oakland, CA (US); Matthias Dantone, Zurich (CH); Paulo R. Jansen dos Reis, San Jose, CA (US)

(21) Appl. No.: 18/695,268

(22) PCT Filed: Sep. 16, 2022
(86) PCT No.: PCT/US2022/043771

§ 371 Date: Mar. 25, 2024

Related U.S. Application Data
(60) Provisional application No. 63/247,971, filed on Sep. 24, 2021.

(51) Int. Cl. G06F 16/583; G06F 3/01; G06F 16/58; G06F 16/587

(52) U.S. Cl. CPC G06F 16/583; G06F 3/011; G06F 16/5866; G06F 16/587

(57) ABSTRACT

In one implementation, a method of storing object information in association with contextual information is performed at a device including an image sensor, one or more processors, and non-transitory memory. The method includes capturing, using the image sensor, an image of an environment. The method includes detecting a user engagement with an object in the environment based on the image of the environment. The method includes, in response to detecting the user engagement with the object, obtaining information regarding the object, obtaining contextual information, and storing, in a database, an entry including the information regarding the object in association with the contextual information.

### CROSS-REFERENCE TO RELATED APPLICATIONS

This application claims priority to U.S. Provisional Patent App. No. 63/247,971, filed on Sep. 24, 2021, which is hereby incorporated by reference in its entirety.

### TECHNICAL FIELD

The present disclosure generally relates to systems, methods, and devices for storing information regarding objects in association with contextual information.

### BACKGROUND

A head-mounted device equipped with a scene camera takes many images of a user's environment. The device can identify objects (e.g., paintings, posters, album covers) in those images. However, information regarding those objects may not be stored in a database that is efficiently indexed.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIGS. 4A-4G illustrate various XR environments during various time periods in accordance with some implementations.

FIG. 5 is a flowchart representation of a method of storing object information in association with contextual information in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for storing object information in association with contextual information. In various implementations, the method is performed by a device including an image sensor, one or more processors, and non-transitory memory. The method includes capturing, using the image sensor, an image of an environment. The method includes detecting a user engagement with an object in the environment based on the image of the environment. The method includes, in response to detecting the user engagement with the object, obtaining information regarding the object, obtaining contextual information, and storing, in a database, an entry including the information regarding the object in association with the contextual information.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

As noted above, a head-mounted device equipped with a scene camera takes many images of a user's environment throughout days or weeks of usage. The device can identify objects (e.g., paintings, posters, album covers) in those images and store information regarding the objects in a database. In order to access the information in an efficient way, the information regarding the objects is stored in association with respective contextual information of the time at which each object is detected, such as a time, location, or current activity. Accordingly, in response to a query of “What was that album cover I was looking at when I was at Jim's house?”, the electronic device can return information regarding a particular album cover detected at a particular time or while at a particular location.

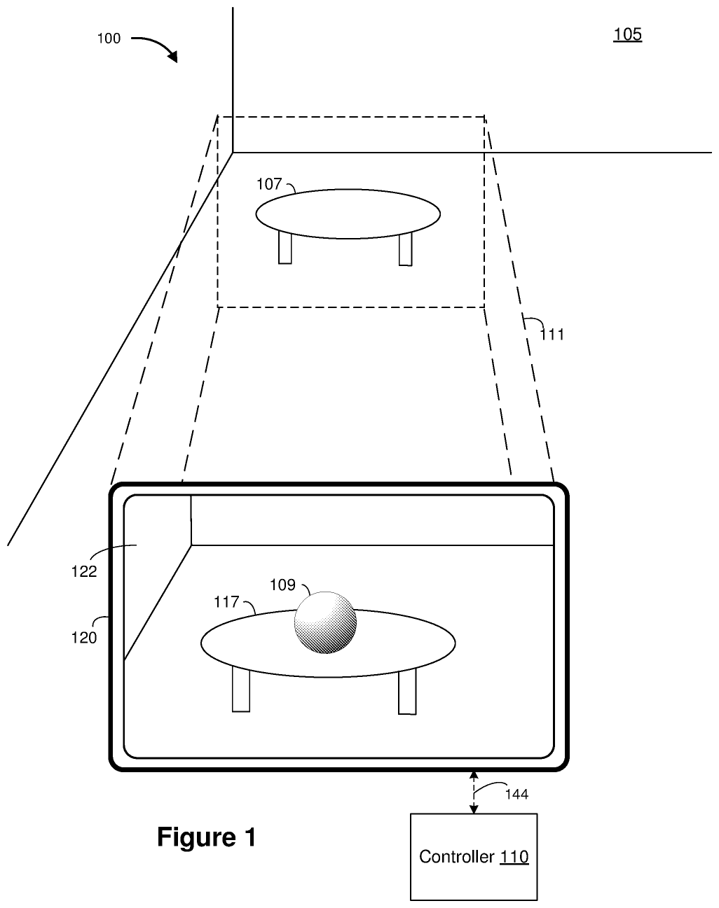

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

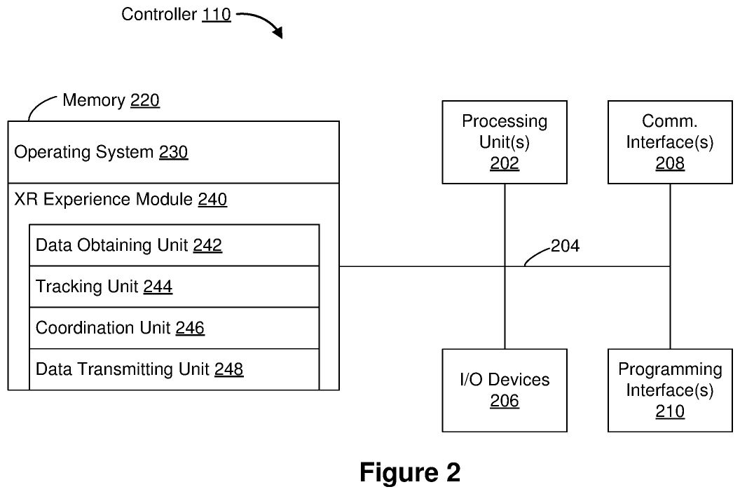

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

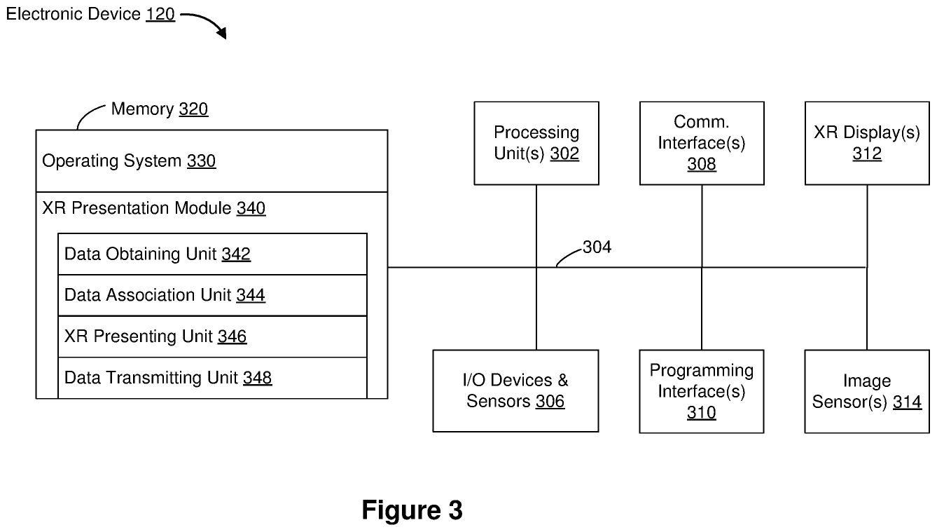

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR sphere 109) and to enable video pass-through of the physical environment 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical environment 105 and to track the position/location of at least the electronic device 120 with respect to the physical environment 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the scene as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, a data association unit 344, an XR presenting unit 346, and a data transmitting unit 348.

In some implementations, the data obtaining unit 342 is configured to obtain data (e.g., presentation data, interaction data, sensor data, location data, etc.) from at least the controller 110 of FIG. 1. In various implementations, the data obtaining unit 342 is configured to obtain data regarding an object detected in an image of the environment at a particular time and to obtain contextual data of the particular time. To that end, in various implementations, the data obtaining unit 342 includes instructions and/or logic therefor, and heuristics and metadata therefor.

In some implementations, the data association unit 344 is configured to associate the data regarding the object and the contextual information and, in various implementations, store the data regarding the object in association with the contextual information. To that end, in various implementations, the data association unit 344 includes instructions and/or logic therefor, and heuristics and metadata therefor.

In some implementations, the XR presenting unit 346 is configured to present XR content via the one or more XR displays 312, such as a visual response to a query. To that end, in various implementations, the XR presenting unit 346 includes instructions and/or logic therefor, and heuristics and metadata therefor.

In some implementations, the data transmitting unit 348 is configured to transmit data (e.g., presentation data, location data, etc.) to at least the controller 110. To that end, in various implementations, the data transmitting unit 348 includes instructions and/or logic therefor, and heuristics and metadata therefor.

Although the data obtaining unit 342, the data association unit 344, the XR presenting unit 346, and the data transmitting unit 348 are shown as residing on a single device (e.g., the electronic device 120), it should be understood that in other implementations, any combination of the data obtaining unit 342, the data association unit 344, the XR presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

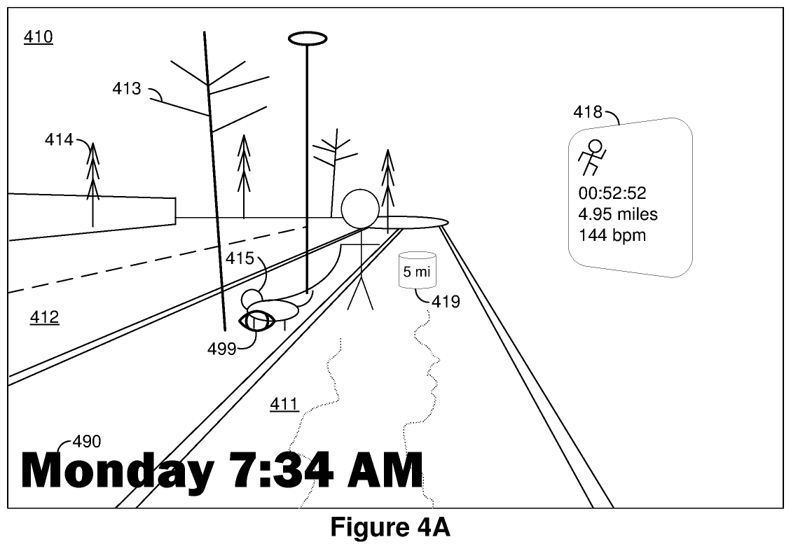

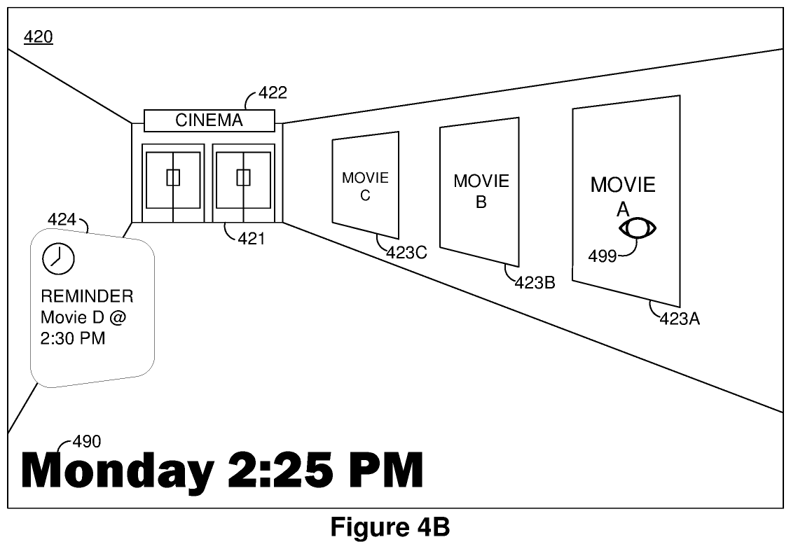

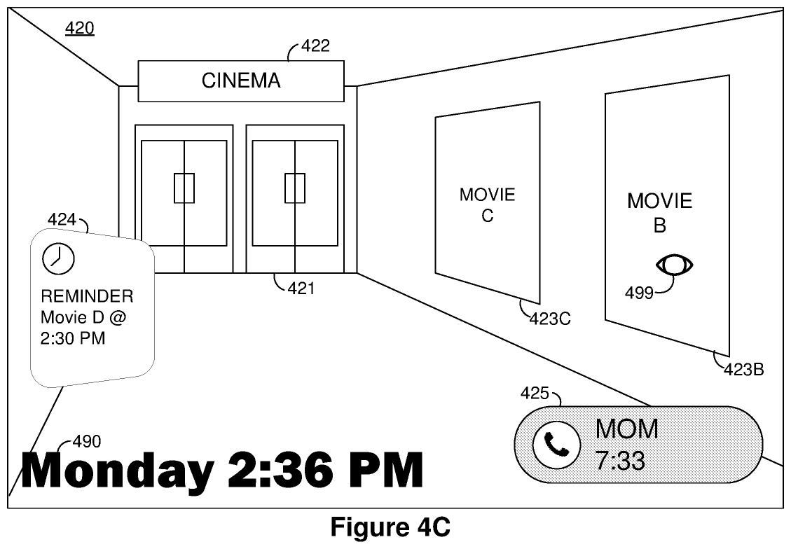

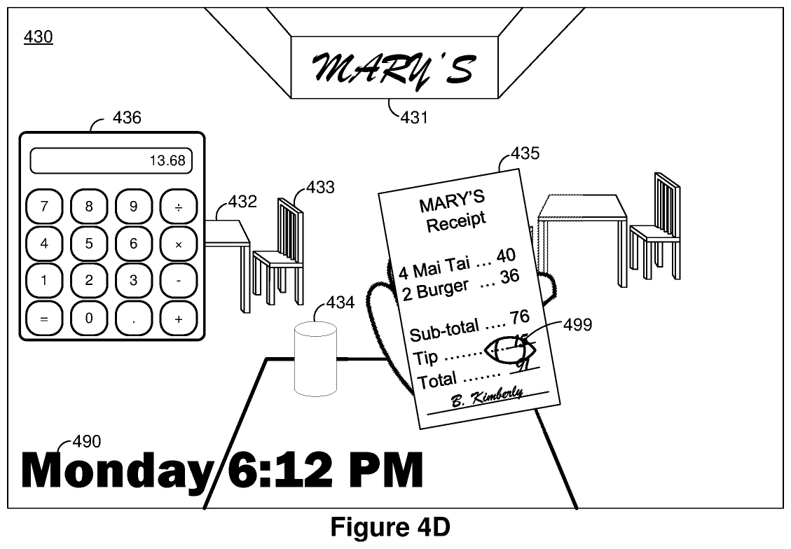

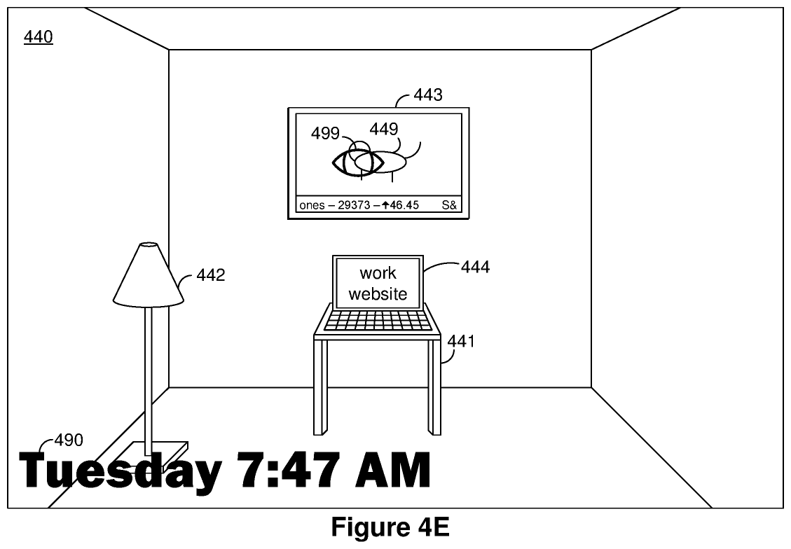

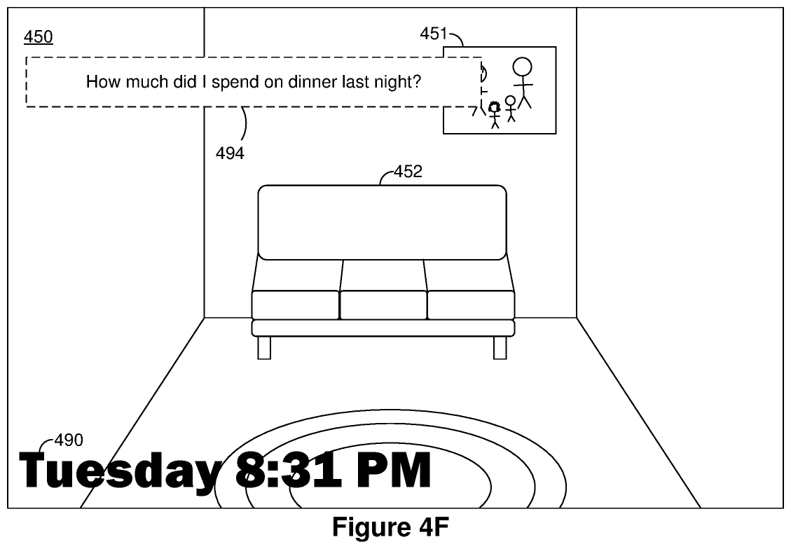

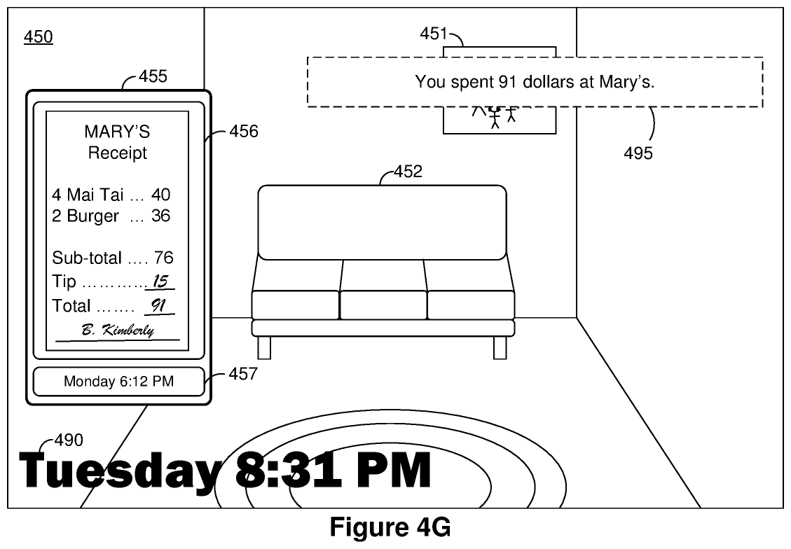

FIGS. 4A-4G illustrate a number of XR environments presented, at least in part, by a display of an electronic device, such as the electronic device 120 of FIG. 3. Each XR environment is based on a physical environment in which the electronic device is present. FIGS. 4A-4G illustrate the XR environments during a series of time periods. In various implementations, each time period is an instant, a fraction of a second, a few seconds, a few hours, a few days, or any length of time.

FIGS. 4A-4G illustrate a gaze location indicator 499 that indicates a gaze location of the user, e.g., where in the respective XR environment the user is looking. Although the gaze location indicator 499 is illustrated in FIGS. 4A-4G, in various implementations, the gaze location indicator is not displayed by the electronic device.

FIG. 4A illustrates a first XR environment 410 during a first time period. The first XR environment 410 is based on an outdoor physical environment in which the electronic device is present.

The first XR environment includes a plurality of objects, including one or more physical objects (e.g., a sidewalk 411, a street 412, a first tree 413, a second tree 414, and a dog 415) of the physical environment and one or more virtual objects (e.g., a virtual clock 490, a virtual running application window 418, and a virtual mile marker 419). In various implementations, certain objects (such as the physical objects and the virtual mile marker 419) are presented at a location in the first XR environment 410, e.g., at a location defined by three coordinates in a common three-dimensional (3D) XR coordinate system such that while some objects may exist in the physical world and the others may not, a spatial relationship (e.g., distance or orientation) may be defined between them. Accordingly, when the electronic device moves in the first XR environment 410 (e.g., changes either position and/or orientation), the objects are moved on the display of the electronic device, but retain their location in the first XR environment 410. Such virtual objects that, in response to motion of the electronic device, move on the display, but retain their position in the first XR environment 410 are referred to as world-locked objects. In various implementations, the location in the first XR environment 410 of certain virtual objects (such as the virtual running application window 418) changes based on the pose of the body of the user. Such virtual objects are referred to as body-locked objects. For example, as the user runs, the virtual running application window 418 maintains a location approximately one meter in front and half a meter to the left of the user (e.g., relative to the position and orientation of the user's torso). As the head of the user moves, without the body of the user moving, the virtual running application window 418 appears at a fixed location in the first XR environment 410.

In various implementations, certain virtual objects (such as the virtual clock 490) are displayed at locations on the display such that when the electronic device moves in the first XR environment 410, the objects are stationary on the display on the electronic device. Such virtual objects that, in response to motion of the electronic device, retain their location on the display are referred to display-locked objects.

FIG. 4A illustrates the first XR environment 410 during a first time period. During the first time period, the user is running on the sidewalk 411 and, as indicated by the gaze indicator 499, looking at the dog 415.

During the first time period, the electronic device detects objects in the first XR environment 410 (e.g., using computer-vision techniques, such as models trained to detect and classify various objects). The electronic device stores information about each of the objects in association with contextual information of the current time. For example, in various implementations, the electronic device detects the first tree 413 and stores information about the first tree 413, such as the species of the tree or the size of the tree. As another example, in various implementations, the electronic device detects the dog 415 and stores information regarding the breed of the dog 415.

In various implementations, the contextual information includes a current time, e.g., Monday at 7:34 AM. In various implementations, the contextual information includes a location of the electronic device at the current time. In various implementations, the contextual information includes a current activity of the user, e.g., running. In various implementations, the electronic device determines the current activity based on captured images of the first XR environment 410, sound detected in the first XR environment 410, and/or motion of the electronic device within the first XR environment 410. In various implementations, the electronic device determines the current activity based on an application executing on the electronic device, e.g., a running application producing the virtual running application window 418 and the virtual mile marker 419.

In various implementations, to reduce storage requirements, the electronic device only stores information about objects with the which the user has engaged. The information about the object and associated contextual information may be stored for times at or around the time of engagement, before engagement (e.g., for a threshold length of time before the engagement using a buffer storing previous information about the object and context), after the engagement (e.g., for a threshold length of time, while the object remains in the user's view or vicinity, while the user is engaged, or the like), or a combination thereof. For example, in various implementations, in response to determining that the user has engaged with the dog 415 by looking at the dog 415 for at least a threshold amount of time, the electronic device stores information regarding the dog 415 in association with the contextual information. In this example, information regarding other objects, such as first tree 413 and second tree 414, may not be stored, absent the same or a similar user engagement therewith.

FIG. 4B illustrates a second XR environment 420 at a second time period subsequent to the first time period. The second XR environment 420 is based on a physical environment of a movie theater in which the electronic device is present.

The second XR environment 420 includes a plurality of objects, including one or more physical objects (e.g., a set of doors 421, a sign 422, a first movie poster 423A, a second movie poster 423B, and a third movie poster 423C) of the physical environment and one or more virtual objects (e.g., the virtual clock 490 and a virtual reminder pop-up 424). The virtual reminder pop-up 424 is a body-locked virtual object.

During the second time period, the user is at a movie theater to see a movie entitled “Movie D” as indicated by the virtual reminder pop-up 424. Further, during the second time period, the user is looking at the first movie poster 423A for the movie entitled “Movie A”, as indicated by the gaze indicator 499.

During the second time period, the electronic device detects objects in the second XR environment 420. The electronic device stores information about each of the objects in association with contextual information of the current time. For example, in various implementations, the electronic device detects the first movie poster 423A and stores information about the first movie poster 423A, such as the title of the movie.

In various implementations, the contextual information includes a current time, e.g., Monday at 2:25 PM. In various implementations, the contextual information includes a current location. In various implementations, the current location is the movie theater named “CINEMA”.

In various implementations, to reduce storage requirements, the electronic device only stores information about objects with the which the user has engaged. The information about the object and associated contextual information may be stored for times at or around the time of engagement, before engagement (e.g., for a threshold length of time before the engagement using a buffer storing previous information about the object and context), after the engagement (e.g., for a threshold length of time, while the object remains in the user's view or vicinity, while the user is engaged, or the like), or a combination thereof. For example, in various implementations, in response to determining that the user has engaged with the first movie poster 423A by looking at the first movie poster 423A for at least a threshold amount of time, the electronic device stores information regarding the first movie poster 423A in association with the contextual information. In this example, information regarding other objects, such as second movie poster 423B and third movie poster 423C, may not be stored, absent the same or a similar user engagement therewith.

FIG. 4C illustrates a second XR environment 420 at a third time period subsequent to the second time period. During the third time period, the second XR environment 420 includes an active call indicator 425 indicating that the user is engaged in a telephone conservation with “MOM” and has been for 7 minutes and 33 seconds. The active call indicator 425 is a display-locked virtual object. Further, during the third time period, the user is looking at the second movie poster for the movie entitled “Movie B”, as indicated by the gaze indicator 499.

During the third time period, the electronic device detects objects in the second XR environment 420. The electronic device stores information about each of the objects in association with contextual information of the current time. For example, in various implementations, the electronic device detects the second movie poster 423B and stores information about the second movie poster 423B, such as the title of the movie.

In various implementations, the contextual information includes a current time, e.g., Monday at 2:36 PM. In various implementations, the contextual information includes a current location. In various implementations, the contextual information includes a current activity of the user, e.g., talking to the user's mother. In various implementations, the electronic device determines the current activity based on captured images of the second XR environment 420, sound detected in the second XR environment 420, and/or motion of the electronic device within the second XR environment 420. In various implementations, the electronic device determines the current activity based on an application executing on the electronic device, e.g., a phone application producing the active call indicator 425.

In various implementations, to reduce storage requirements, the electronic device only stores information about objects with the which the user has engaged. The information about the object and associated contextual information may be stored for times at or around the time of engagement, before engagement (e.g., for a threshold length of time before the engagement using a buffer storing previous information about the object and context), after the engagement (e.g., for a threshold length of time, while the object remains in the user's view or vicinity, while the user is engaged, or the like), or a combination thereof. For example, in various implementations, in response to determining that the user has engaged with the second movie poster 423B by looking at the second movie poster 423B for at least a threshold amount of time, the electronic device stores information regarding the second movie poster 423B in association with the contextual information. In this example, information regarding other objects, such as third movie poster 423C, may not be stored, absent the same or a similar user engagement therewith.

FIG. 4D illustrates a third XR environment 430 at a fourth time period subsequent to the third time period. The third XR environment 430 is based on a physical environment of a restaurant in which the electronic device is present.

The third XR environment 430 includes a plurality of objects, including one or more physical objects (e.g., a sign 431, a table 432, a chair 433, a glass 434, and a receipt 435) of the physical environment and one or more virtual objects (e.g., the virtual clock 490 and a virtual calculator 436). The virtual calculator 436 is a world-locked virtual object.

During the fourth time period, the user has just used the virtual calculator 436 to determine an amount to tip and has both filled in and signed the receipt 435. Further, during the fourth time period, the user is looking at the receipt 435, as indicated by the gaze indicator 499.

During the fourth time period, the electronic device detects objects in the third XR environment 430. The electronic device stores information about each of the objects in association with contextual information of the current time. For example, in various implementations, the electronic device detects the sign 431 and stores information about the sign 431, such as the text of the sign (e.g., “MARY'S”, the name of the restaurant). As another example, in various implementations, the electronic device detects the receipt 435 and stores information about the receipt 435, such as the text of the receipt 435. In various implementations, the information about the receipt 435 is based on the text of the receipt 435 and includes such information as items ordered and/or the total amount spent.

In various implementations, the contextual information includes a current time, e.g., Monday at 6:12 PM. In various implementations, the contextual information includes a current location. In various implementations, the current location is the restaurant named “MARY'S”.

In various implementations, to reduce storage requirements, the electronic device only stores information about objects with the which the user has engaged. The information about the object and associated contextual information may be stored for times at or around the time of engagement, before engagement (e.g., for a threshold length of time before the engagement using a buffer storing previous information about the object and context), after the engagement (e.g., for a threshold length of time, while the object remains in the user's view or vicinity, while the user is engaged, or the like), or a combination thereof. For example, in various implementations, in response to determining that the user has engaged with the receipt 435 by looking at the receipt 435 for at least a threshold amount of time and/or by holding the receipt 435, the electronic device stores information regarding the receipt 435 in association with the contextual information. In this example, information regarding other objects, such as sign 431, table 432, chair 433, and glass 434, may not be stored, absent the same or a similar user engagement therewith

FIG. 4E illustrates a fourth XR environment 440 at a fifth time period subsequent to the fourth time period. The fourth XR environment 440 is based on a physical environment of a home office in which the electronic device is present.

The fourth XR environment 440 includes a plurality of objects, including one or more physical objects (e.g., a desk 441, a lamp 442, a television 443, and a laptop 444) of the physical environment and one or more virtual objects (e.g., the virtual clock 490).

During the fifth time period, the television 443 is playing a news story about a local dog. Further, during the fifth time period, the user is watching the news story, as indicated by the gaze indicator 499.

During the fifth time period, the electronic device detects objects in the fourth XR environment 430. The electronic device stores information about each of the objects in association with contextual information of the current state time. For example, in various implementations, the electronic device detects the television 443 and stores information about the television 443, such as the current channel or program. As another example, in various implementations, the electronic device detects the laptop 444 and stores information about the laptop 444, such as the current website or application open on the laptop 444. In various implementations, the electronic device detects objects displayed by other electronic devices as though the objects were in the physical environment. For example, in various implementations, the electronic device detects the dog 449 displayed by the television 443 and stores information regarding the dog 449, such as the breed of the dog 449, in association with the contextual information. As another example, in various implementations, the electronic device detects an object displayed by the laptop 444 and stores information regarding the object in association with contextual information.

In various implementations, the contextual information includes a current time, e.g., Tuesday at 7:47 AM. In various implementations, the contextual information includes a current location. In various implementations, the contextual information includes a current activity, e.g., watching the television 443.

In various implementations, to reduce storage requirements, the electronic device only stores information about objects with the which the user has engaged. The information about the object and associated contextual information may be stored for times at or around the time of engagement, before engagement (e.g., for a threshold length of time before the engagement using a buffer storing previous information about the object and context), after the engagement (e.g., for a threshold length of time, while the object remains in the user's view or vicinity, while the user is engaged, or the like), or a combination thereof. For example, in various implementations, in response to determining that the user has engaged with the dog 449 by looking at the dog 449 for at least a threshold amount of time, the electronic device stores information regarding the dog 449 in association with the contextual information. In this example, information regarding other objects, such as desk 441, lamp 442, and laptop 444, may not be stored, absent the same or a similar user engagement therewith

FIG. 4F illustrates a fifth XR environment 450 at a sixth time period subsequent to the fifth time period. The fifth XR environment 450 is based on a physical environment of a living room in which the electronic device is present.

The fifth XR environment 450 includes a plurality of objects, including one or more physical objects (e.g., a picture 451 and a couch 452) of the physical environment and one or more virtual objects (e.g., the virtual clock 490 and a query indicator 494). The query indicator 494 is a display-locked virtual object displayed by the electronic device in response to a vocal query from the user. For example, during the sixth time period, the user has vocally asked “How much did I spend on dinner last night?” Although FIG. 4F illustrates the query indicator 494 as a display-locked virtual object, in various implementations, the query indicator 494 is not displayed.

FIG. 4G illustrates the fifth XR environment 450 at a seventh time period subsequent to the sixth time period. In various implementations, the information regarding the detected objects stored in association with the contextual information is stored in a searchable database. In response to the vocal query, the electronic device searches the database to generate a response. For example, in response to the vocal query of “How much did I spend on dinner last night?”, the electronic device searches the database for entries including information regarding objects related to spending (e.g., a receipt, cash, a credit card, a cash register, or a point-of-sale device) and associated contextual information related to the previous evening (e.g., Monday between 4:00 PM and 10:00 PM). Thus, continuing the example, to generate a response to vocal query, the electronic device retrieves an entry including information regarding the receipt 435 of the third environment 430 illustrated in FIG. 4D and associated contextual information including a time of Monday at 6:12 PM. The entry includes information regarding the receipt 435 including the total amount spent which the electronic device uses to generate the response.

During the seventh time period, the query indicator 494 is replaced with a response indicator 495. The response indicator 495 is a display-locked virtual object displayed by the electronic device while an audio response to the vocal query is produced by the device. For example, during the seventh time period, the electronic device produces the sound of voice saying “You spent 91 dollars at Mary's.” Although FIG. 4G illustrates the response indicator 495 as a display-locked virtual object, in various implementations, the response indicator 495 is not displayed while the audio response is produced by the device.

During the seventh time period, the fifth XR environment 450 includes a response window 455 including information from the retrieved entry. For example, in FIG. 4G, the response window 455 includes an image 456 of the receipt 435 captured during the fourth time period of FIG. 4D and a time 457 the image 456 was captured. Thus, by viewing the response window 455, a user can confirm that the information in the response is correct.

Whereas FIG. 4F and FIG. 4G illustrate an example query and response, in various implementations, the electronic device can generate a variety of different responses to answer various queries. For example, in various implementations, the query is “What was in that drink I had at Mary's?” To generate the response, the electronic device searches the database for entries including information regarding objects related to eating or drinking (e.g., a receipt from a restaurant or a recipe book) and associated contextual information related to the location of the restaurant named “Mary's”. Thus, continuing the example, to generate a response to vocal query, the electronic device retrieves an entry including information regarding the receipt 435 of the third environment 430 illustrated in FIG. 4D and associated contextual information including a location of the restaurant named “Mary's”. The entry includes information regarding the receipt 435 including that a “Mai Tai” was ordered which the electronic device uses to generate the response by searching for the ingredients of that drink.

As another example, in various implementations, the query is “What was the movie poster I saw when I was on the phone with my Mom?” To generate the response, the electronic device searches the database for entries including information regarding objects related to movies (e.g., movie posters) and associated contextual information related to being on the phone with the user's mother. Thus, continuing the example, to generate a response to vocal query, the electronic device retrieves an entry including information regarding the second movie poster 423B of the second environment 420 illustrated in FIG. 4C and associated contextual information including being on the phone with the user's mother. The electronic device does not retrieve an entry including information regarding the first movie poster 423A of the second environment 420 illustrated in FIG. 4B because that entry is not associated with contextual information including being on the phone with the user's mother. The retrieved entry includes information regarding the second movie poster 423B including the title of the movie entitled “Movie B” which the electronic device uses to generate the response.

As another example, in various implementations, the query is “What kind of dog did I see on my run this morning?” To generate the response, the electronic device searches the database for entries including information regarding objects related to dogs and associated contextual information related to running and the morning of the current day (e.g., Tuesday between 5:00 AM and 11:00 AM). In this example, there are no entries in the database including information regarding dogs and associated contextual information including both running and this morning. However, to generate a response to vocal query, the electronic device retrieves a first entry including information regarding the dog 415 of the first environment 410 illustrated in FIG. 4A and associated contextual information including running but not this morning and retrieves a second entry including information regarding the dog 443 of the fourth environment 410 of FIG. 4E and associated contextual information including this morning but not running. The retrieved entry includes information regarding the dog 415 and the dog 443 including their breeds which the electronic device uses to generate the response which may indicate that the entries are not an exact match. For example, in various implementations, the response is “I couldn't find a dog you saw while running this morning. You saw a Shiba Inu while running yesterday morning and you saw a Husky on television this morning.”

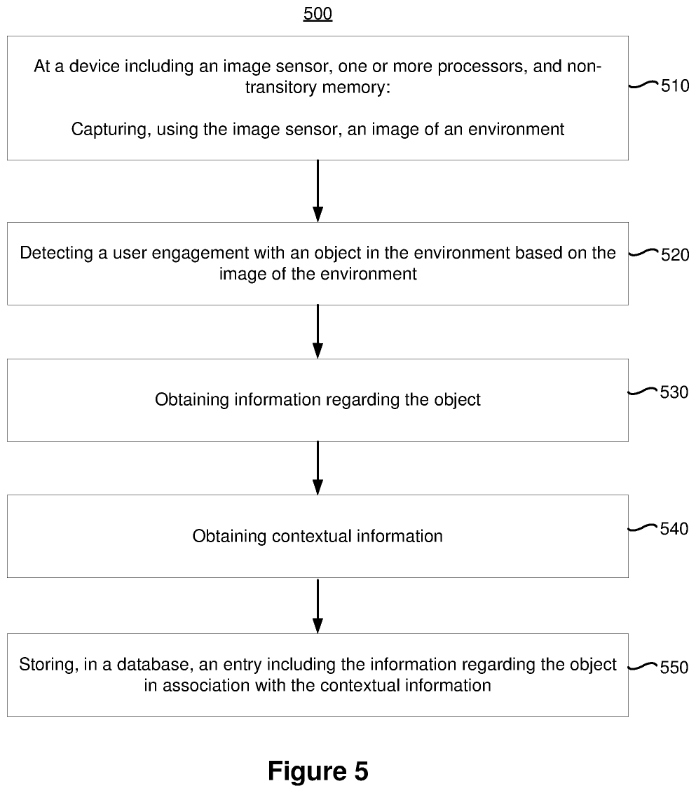

FIG. 5 is a flowchart representation of a method 500 of storing object information in association with contextual information in accordance with some implementations. In various implementations, the method 500 is performed by a device including an image sensor, one or more processors, and non-transitory memory (e.g., the electronic device 120 of FIG. 3). In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device capturing, using the image sensor, an image of an environment. For example, in FIG. 4A, the electronic device captures an image of the outdoor physical environment on which the first XR environment 410 is based. As another example, in FIG. 4D, the electronic device captures an image of the physical environment of the restaurant on which the third XR environment 430 is based.

The method 500 continues, in block 520, with the device detecting user engagement with an object in the environment based on the image of the environment. For example, in FIG. 4A, the electronic device detects the user looking at the dog 415 in the image of the outdoor physical environment. As another example, in FIG. 4B, the electronic device detects the user looking at the first movie poster 423A in the image of the physical environment of the movie theater on which the second XR environment 420 is based.

In various implementations, detecting the user engagement with the object includes detecting that the user has looked at the object for at least a threshold amount of time. In various implementations, detecting user engagement with the object includes detecting that the user has physically interacted with the object, e.g., manually interacted with the object. For example, in various implementations, the device detects a user drinking from a soda can without looking at the soda can. In response, the device obtains information regarding the soda can, such as a brand of soda or a calorie count. In various implementations, in response to detecting the object, the device displays a detection indicator in association with the object (e.g., a small glowing circle or glint). In various implementations, detecting the user engagement with the object includes detecting a selection of the detection indicator. In various implementations, in response to detecting selection of the detection indicator, in addition to obtaining the information regarding the object, the device displays the information regarding the object in association with the object.

The method 500 continues, in block 530, with the device, in response to detecting the user engagement with the object, obtaining information regarding the object. In various implementations, the information regarding the object includes machine-readable content associated with the object. In various implementations, the machine-readable content includes text, a one-dimensional barcode, or a two-dimensional barcode. In various implementations, the machine-readable content is printed on the object. Thus, in various implementations, the machine-readable content is detected in a region of the image within a region of the image in which the object is represented. In various implementations, the machine-readable content is displayed next to the object. For example, at a store, a label including machine-readable content identifying the object for sale may be displayed on a shelf or container containing the object (or multiple instances of the object). Thus, in various implementations, the machine-readable content is detected in a region of the image proximate to the region of the image in which the object is represented. In various implementations, the machine-readable content is associated with the object via a key or legend. In various implementations, the machine-readable content is associated with the object via an arrow or lead line. For example, in FIG. 4D, the electronic device obtains information regarding the receipt 435 by parsing the text printed on the receipt, including the total amount spent and the items ordered.

In various implementations, the information regarding the object includes an object type of the object. For example, in FIG. 4A, the electronic device detects the dog 415 and obtains information regarding the dog 415 that it is a “DOG”. As another example, in FIG. 4A, the electronic device detects the first tree 413 and obtains information regarding the first tree 413 that it is a “PLANT”. In various implementations, the information regarding the object includes an object subtype of the object type of object. For example, in FIG. 4A, the electronic device detects the dog 415 and obtains information regarding the dog 415 that is a “DOG” and a particular type of “DOG”, e.g., a “SHIBA INU” “DOG”. As another example, in FIG. 4A, the electronic device detects the first tree 413 and obtains information regarding the first tree 413 that it is a “PLANT” and a particular type of “PLANT”, e.g., a “SPRUCE TREE” “PLANT”.

In various implementations, the device obtains the object type of the object using a neural network classifier configured to classify images of various objects as one of various object types. In various implementations, the device obtains the object subtype of the object using a neural network classifier configured to classify image of a particular object type as one of various object subtypes. For example, in FIG. 4A, the electronic device classifies the dog 415 as a “DOG” and the first tree 413 as a “PLANT” using a first neural network configured to classify images objects as various object types, further classifies the dog 415 as a “SHIBA INU” “DOG” using a second neural network configured to classify images of dogs as various breeds, and further classifies the first tree 413 as a “SPRUCE TREE” “PLANT” using a third neural network configured to classify images of plants as various species.

The method 500 continues, in block 540, with the device, in response to detecting the user engagement with the object, obtaining contextual information. In various implementations, the contextual information includes an indication of a time at which the image of the environment was captured. For example, in FIG. 4A, the contextual information stored in association with the information regarding the dog 415 includes the particular time of Monday at 7:34 AM. In various implementations, the contextual information includes a location of the device at a time at which the image of the environment was captured. In various implementations, the location of the device is represented by latitude and longitude coordinates, e.g., as determined by a GPS sensor. In various implementations, the location of the device is an address or the name of a business at that address. For example, in FIG. 4B, the contextual information includes the location of the device at the movie theater named “CINEMA”.

In various implementations, the contextual information includes an application executing on the device at a time the image of the environment was captured. For example, in FIG. 4C, the contextual information includes the execution of the phone application producing the active call indicator 425. In various implementations, the contextual information includes an activity of a user of the device being performed at a time the image of the environment was captured. For example, in FIG. 4A, the contextual information includes that the user is running.

In various implementations, the contextual information about the object may be obtained for times at or around the time of engagement, before engagement (e.g., for a threshold length of time before the engagement using a buffer storing previous information about the object and context), after the engagement (e.g., for a threshold length of time, while the object remains in the user's view or vicinity, while the user is engaged, or the like), or a combination thereof.

The method 500 continues, in block 550, with the device, in response to detecting the user engagement with the object, storing, in a database, an entry including the information regarding the object in association with contextual information of the particular time. In various implementations, the entry further includes the image of the environment. In various implementations, the database is stored on the device, e.g., the non-transitory memory. In various implementations, the database is stored on a server remote from the device.

In various implementations, the database is queryable or searchable. Accordingly, in various implementations, the method 500 further includes receiving a query. In various implementation, the query is received from a user. In various implementations, the query received from the user is a verbal query including one or more words. In various implementations, the query received from the user is a vocal query. For example, in FIG. 4F, the electronic device receives the vocal query “How much did I spend on dinner last night,” as indicated by the query indicator 494. In various implementations, the query is received from an application.

In various implementations, the query includes a first portion relating to information regarding objects in the entries of the database and a second portion relating to contextual information in the entries of the database. For example, the query “What was in that drink I had at Mary's” includes a first portion (e.g., “drink”) relating to detected objects and a second portion (e.g., “at Mary's”) relating to contextual information, in particular, a location. As another example, the query “What was that movie poster I saw when I was on the phone with my mom?” includes a first portion (e.g., “movie poster”) relating to detected objects and a second portion (e.g., “on the phone”) relating to contextual information, in particular, an executing phone application.

In various implementations, the method 500 includes selecting one or more entries in the database based on the query and generating a response to the query based on the one or more entries. For example, in FIG. 4G, the electronic device searches the database for entries including information regarding objects related to spending and associated contextual information related to the previous evening, retrieves an entry including information regarding the receipt 435 of the third environment 430 illustrated in FIG. 4D and associated contextual information including a time of Monday at 6:12 PM, and provides the response “You spent 91 dollars at Mary's” as indicated by the response indicator 495.

In various implementations, generating the response includes generating a verbal response including one or more words. In various implementations, generating the response includes generating an audio response. For example, in FIG. 4G, in addition to displaying the response indicator 495, the electronic device produces the sound of voice saying “You spent 91 dollars at Mary's.” In various implementations, generating the response includes displaying a response window including at least a portion of the image of the environment. For example, in FIG. 4G, the electronic device displays the response window 455 including the image 456.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1-17. (canceled)

18. A method comprising:
at a device including an image sensor, one or more processors, and non-transitory memory:
capturing, using the image sensor, an image of an environment;
detecting a user engagement with an object in the environment based on the image of the environment; and
in response to detecting the user engagement with the object:
obtaining information regarding the object;
obtaining contextual information; and
storing, in a database, an entry including the information regarding the object in association with the contextual information.

19. The method of claim 18, wherein the information regarding the object includes machine-readable content associated with the object.

20. The method of claim 18, wherein the information regarding the object includes an object type of the object.

21. The method of claim 18, wherein the contextual information includes a time at which the image of the environment was captured.

22. The method of claim 18, wherein the contextual information includes a location of the device at a time at which the image of the environment was captured.

23. The method of claim 18, wherein the contextual information includes an application executing on the device at a time at which the image of the environment was captured.

24. The method of claim 18, wherein the contextual information includes an activity of a user of the device being performed at a time at which the image of the environment was captured.

25. The method of claim 18, wherein detecting the user engagement with the object includes detecting that the user has looked at the object for at least a threshold amount of time.

26. The method of claim 18, wherein detecting the user engagement with the object includes detecting that the user has physically interacted with the object.

27. The method of claim 18, further comprising:
receiving a query;
selecting one or more entries in the database based on the query; and
generating a response to the query based on the one or more entries.

28. The method of claim 27, wherein the query includes a first portion relating to information regarding objects in the entries of the database and a second portion relating to contextual information in the entries of the database.

29. The method of claim 27, wherein generating the response includes generating a verbal response.

30. The method of claim 27, wherein generating the response includes displaying a response window including at least a portion of the image of the environment.

31. A device comprising:
an image sensor;
a non-transitory memory; and
one or more processors to:
capture, using the image sensor, an image of an environment;
detect a user engagement with an object in the environment based on the image of the environment; and
in response to detecting the user engagement with the object:
obtain information regarding the object;
obtain contextual information; and
store, in a database, an entry including the information regarding the object in association with the contextual information.

32. The device of claim 31, wherein the one or more processors are further to:
receive a query;
select one or more entries in the database based on the query; and
generate a response to the query based on the one or more entries.

33. The device of claim 32, wherein the query includes a first portion relating to information regarding objects in the entries of the database and a second portion relating to contextual information in the entries of the database.

34. The device of claim 32, wherein the one or more processors are to generate the response by generating a verbal response.

35. A non-transitory computer-readable medium having instructions encoded thereon which, when executed by a device including a processor and an image sensor, causes the device to:
capture, using the image sensor, an image of an environment;
detect a user engagement with an object in the environment based on the image of the environment; and
in response to detecting the user engagement with the object:
obtain information regarding the object;
obtain contextual information; and
store, in a database, an entry including the information regarding the object in association with the contextual information.

36. The non-transitory computer-readable medium of claim 35, wherein the instructions, when executed, further cause the device to:
receive a query;
select one or more entries in the database based on the query; and
generate a response to the query based on the one or more entries.

37. The non-transitory computer-readable medium of claim 36, wherein the query includes a first portion relating to information regarding objects in the entries of the database and a second portion relating to contextual information in the entries of the database.
